(19) United States
(12) Patent Application Publication
(10) Pub. No.: US 2011/0219776 A1
(43) Pub. Date: Sep. 15, 2011

(54) AERODYNAMIC FLAME STABILIZER

(75) Inventors: Ronald Scott Bunker, Niskayuna, NY (US); Andrei Tristan Evulet, Clifton Park, NY (US)

(73) Assignee: GENERAL ELECTRIC COMPANY, SCHENECTADY, NY (US)

(21) Appl. No.: 12/724,366

(22) Filed: Mar. 15, 2010

(51) Int. Cl. F23R 3/18; F02C 7/22; F02C 3/14

(52) U.S. Cl. 60/772; 60/740; 60/749

(57) ABSTRACT

A flame stabilizer is in fluid communication with a combustor of a gas turbine engine. The flame stabilizer has a body with an aerodynamic shape that creates a flow recirculation zone by injection of fluid through a plurality of holes in the body of the flame stabilizer. The aerodynamic shape of the body reduces pressure loss in the combustor, particularly when no fuel is being provided to the combustor. In addition, the magnitude of the flow recirculation zone can be modulated by selectively adjusting the flow rate of fluid through the holes, or by selectively adjusting the size of the holes.

### BACKGROUND

The invention relates generally to fuel injection systems, and more particularly to a gas turbine system with a reheat combustor.

A gas turbine system includes at least one compressor, a first combustion chamber located downstream of the at least one compressor and upstream of a first turbine, and a second combustion chamber (may also be referred to as “reheat combustor”) located downstream of the first turbine and upstream of a second turbine. A mixture of compressed air and a fuel is ignited in the first combustion chamber to generate a working gas. The working gas flows through a transition section to a first turbine. The first turbine has a cross-sectional area that increases towards a downstream side. The first turbine includes a plurality of stationary vanes and rotating blades. The rotating blades are coupled to a shaft. As the working gas expands through the first turbine, the working gas causes the blades, and therefore the shaft, to rotate.

The power output of the first turbine is proportional to the temperature of the working gas in the first turbine. That is, the higher the temperature of the working gas, the greater the power output of the turbine assembly. To ensure that the working gas has energy to transfer to the rotating blades within the second turbine, the working gas must be at a high working temperature as the gas enters the second turbine. However, as the working gas flows from the first turbine to the second turbine, temperature of the working gas is reduced. Thus, the power output generated from the second turbine is less than optimal. The amount of power output from the second turbine could be increased if the temperature of the working gas within the second turbine is increased. The working gas is further combusted in the second combustion chamber so as to increase the temperature of the working gas in the second turbine.

In some conventional gas turbine engines, the second combustion chamber (“reheat combustor”) includes a plurality of flame holders or flame stabilizers that inject a fluid, such as gaseous fuel and air, into the second combustion chamber. The conventional flame stabilizers are commonly shaped as bluff bodies for the purpose of attaining a well-defined flow separation and flow recirculation zone that allows flame to circulate axially and continuously provide ignition to the fuel-air mixture. Another common form for conventional stabilizers is the so-called “dump” region or sudden expansion in the flow path that creates a deliberate axial recirculation of flow. However, a reheat combustor that uses flame stabilizers must operate in fully fired conditions, part load conditions, and also be capable of simply flowing the gases from the upstream turbine without combustion.

### SUMMARY

The inventors have discovered that the non-fired condition presents about 3% to 5% pressure drop in the gas turbine engine due to the presence of the bluff body shape of conventional flame stabilizers. This pressure drop is a severe reduction of available work that can be extracted by the gas turbine engine, thereby reducing an overall efficiency of the gas turbine engine.

In accordance with the invention, the unwanted pressure loss in the gas turbine engine due to flame stabilizers in the shape of bluff bodies is solved in one aspect by an aerodynamic flame stabilizer in which a flow recirculation zone is created by the injection of fluid through holes in the flame stabilizer. This aspect allows an increase in efficiency of the gas turbine engine. In addition, this aspect allows the flow recirculation zone to be modulated by controlling the injection of fluid through the flame stabilizer. The flow recirculation zone can also be modulated by the included angle of the holes in the flame stabilizer.

Two main benefits are obtained from the invention. First, the size/strength of the flow recirculation zone can be controlled through modulation of the fluid flow rate in the stabilizer. Second, the flame stabilizer becomes a very low-pressure loss device to conserve available work to be extracted by the gas turbine engine when the combustor is not fired.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic cross-sectional illustration of an exemplary gas turbine engine;

FIG. 2 is a diagrammatical representation of a gas turbine engine having flame stabilizers in fluid communication with a reheat combustor of the gas turbine system in accordance with an exemplary embodiment;

FIG. 3 is a diagrammatical representation of a flame stabilizer in accordance with an exemplary embodiment of the present invention; and

FIG. 4 is a cross-sectional view taken along line 4-4 of FIG. 3.

### DETAILED DESCRIPTION

As used herein, “upstream” refers to a forward end of a gas turbine engine, and “downstream” refers to an aft end of a gas turbine engine. As used herein, an “aerodynamic” shape is a shape having zero lift, or low lift with some turning. As used herein, a “bluff” body shape is a shape having zero lift or low lift, but has a tremendous separated wake region generated just by the flow over the body.

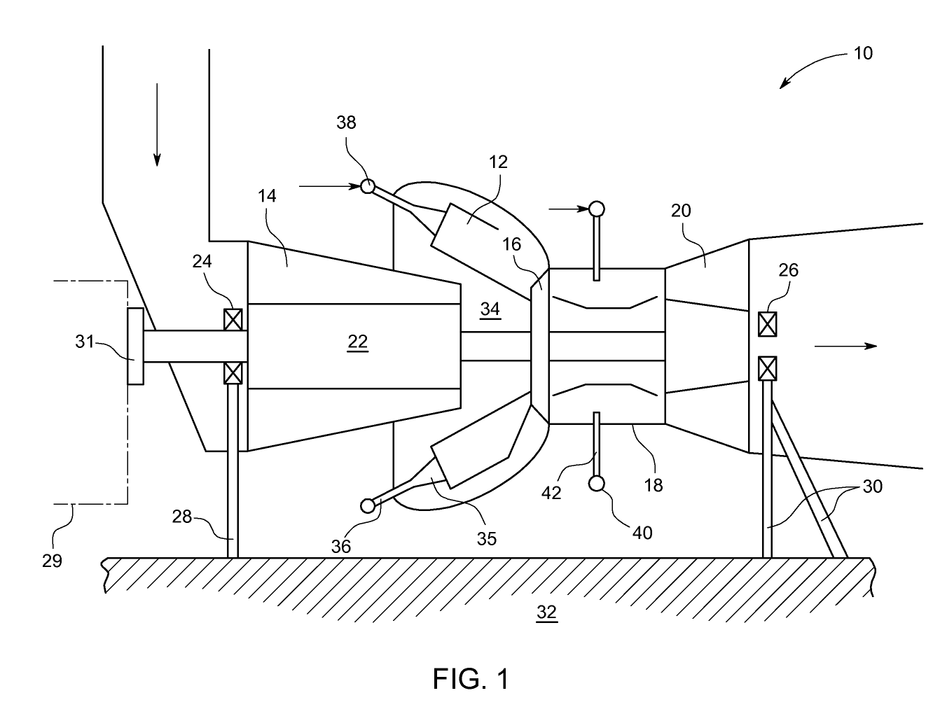

Referring to FIG. 1, an exemplary combustor system, for example, a gas turbine system 10 is disclosed. It should be noted herein that the configuration of the illustrated gas turbine system 10 is an exemplary embodiment and should not be construed as limiting. The configuration may vary depending on the application. The gas turbine system 10 includes a first combustion chamber 12 (may also be referred to as “first combustor”) disposed downstream of a compressor 14. A first turbine 16 is disposed downstream of the first combustion chamber 12. A second combustion chamber 18 (may also be referred to as “reheat combustor”) is disposed downstream of the first turbine 16. A second turbine 20 is disposed downstream of the second combustion chamber 18. The compressor 14, the first turbine 16, and the second turbine 20 have a single rotor shaft 22. It should be noted herein that provision of a single rotor shaft should not be construed as limiting. In another embodiment, the second turbine 20 may have a separate drive shaft. In the illustrated embodiment, the rotor shaft 22 is supported by two bearings 24, 26 disposed at a front end of the compressor 14 and downstream of the second turbine 20. The bearings 24, 26 are mounted respectively on anchor units 28, 30 coupled to a foundation 32. The rotor shaft 22 is coupled to a generator 29 via a coupling 31.

The compressor stage can be subdivided into two partial compressors (not shown) in order, for example, to increase the specific power depending on the operational layout. The induced air after compression flows into a casing 34 disposed enclosing an outlet of the compressor 14 and the first turbine 16. The first combustion chamber 12 is accommodated in the casing 34. The first combustion chamber 12 has a plurality of burners 35 distributed on a periphery at a front end and configured to maintain generation of a hot gas. Fuel lances 36 coupled together through a main ring 38 are used to provide fuel supply to the first combustion chamber 12. The hot gas (first combustion gas) from the first combustion chamber 12 act on the first turbine 16 immediately downstream, resulting in thermal expansion of the hot gases. The partially expanded hot gases from the first turbine 16 flow directly into the second combustion chamber 18.

The second combustion chamber 18 may have different geometries. In the illustrated embodiment, the second combustion chamber 18 is an aerodynamic path between the first turbine 16 and the second turbine 20 having required length and volume to allow reheat combustion. In an exemplary embodiment, a flame stabilizer 40 is disposed radially within the second combustion chamber 18. The flame stabilizer 40 is configured to inject additional fluid, such as fuel, air, or a combination of both, during reheat operation for burning in the second combustion chamber 18.

The flame stabilizer 40 includes an elongated body 42 having a generally cylindrical shape. While a generally cylindrical shape has been shown and described, it will be appreciated that other shapes (such as generally conical) may be utilized to define the body 42 without departing from the spirit or scope of the invention. The body 42 has a length sufficient to extend into the second combustion chamber 18. The body 42 is composed of any suitable material having the ability to heat up and retain the high temperature resulting from the heat flux. Such material includes, but is not limited to, tungsten and tungsten alloys, and lower grade alloys, such as HastX, and the like.

Hot gas (second combustion gas) generated from the second combustion chamber 18 is subsequently fed to the second turbine 20. The hot gas from the second combustion chamber 18 acts on the second turbine 20 immediately downstream, resulting in thermal expansion of the hot gases. It should be noted herein that even though the flame stabilizer 40 is explained with reference to a reheat combustor, the exemplary flame stabilizer 40 could be applied for any combustors.

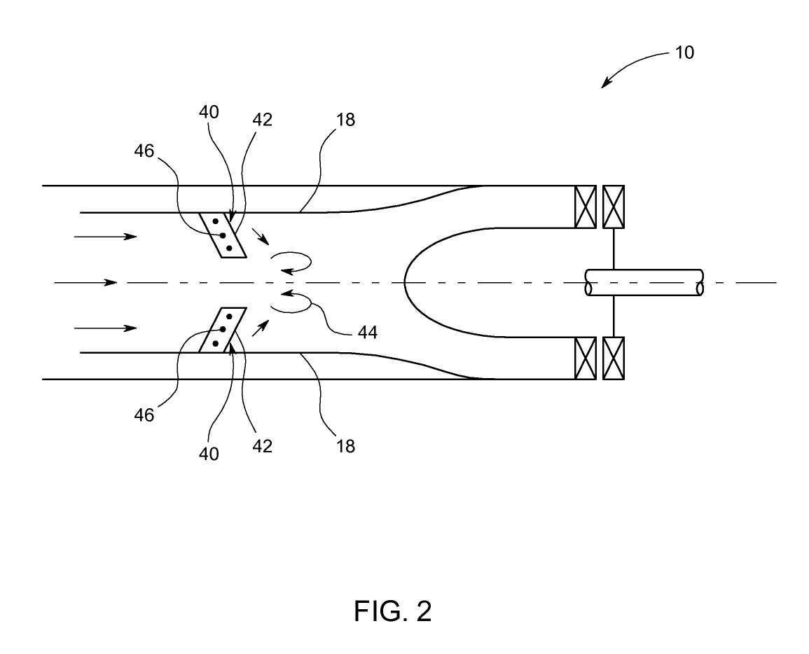

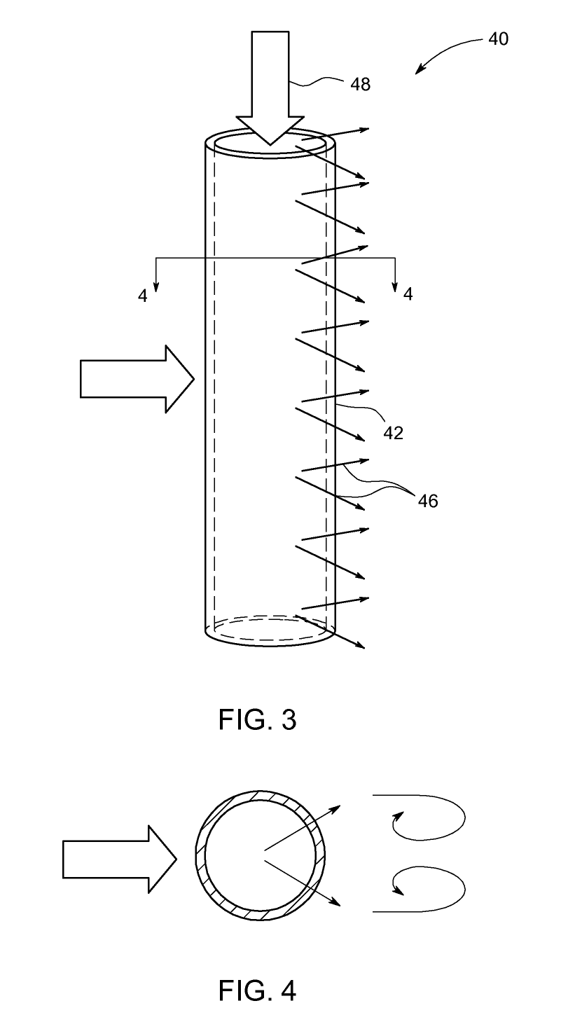

Referring to FIGS. 2-4, the aerodynamic flame stabilizer 40 of the invention is disclosed. As discussed previously, the flame stabilizer 40 is disposed radially within the second combustion chamber (reheat combustor) and configured to inject fluid, such as fuel, air, or a combination of both, into the second combustion chamber 18. Rather than a bluff body shape as in conventional flame stabilizers, the body 42 of the flame stabilizer 40 has an aerodynamic shape. An aft flow recirculation zone 44 is formed by the injection of fluid 48, such as fuel, air, or a combination of both, through appositively angled jet holes or slots 46 formed in the member 42, as shown by the arrows in FIGS. 2-4. The size or magnitude of the flow recirculation zone 44 can be modulated by a couple of different ways. One way to selectively adjust the magnitude of the flow recirculation zone 44 is to selectively adjust the size of the holes or slots 46. The smaller the size of the holes or slots 46, the smaller the size of the flow recirculation zone 44, and vice versa. Another way to selectively adjust the magnitude of the flow recirculation zone 44 is the selectively adjust the flow rate of the fluid through the holes or slots 46. The smaller the flow rate, the smaller the size of the flow recirculation zone 44, and vice versa.

As described above, the unwanted pressure loss in a gas turbine engine due to flame stabilizers in the shape of bluff bodies is solved in one aspect by an aerodynamic flame stabilizer in which a flow recirculation zone is created by the injection of fluid through holes in the flame stabilizer. This aspect allows an increase in efficiency of the gas turbine engine. In addition, this aspect allows the flow recirculation zone to be modulated by controlling the injection of fluid through the flame stabilizer. The flow recirculation zone can also be modulated by the included angle of the holes in the flame stabilizer.

Two main benefits are obtained from the invention. First, the size/strength of the flow recirculation zone can be controlled through modulation of the fluid flow rate in the stabilizer. Second, the flame stabilizer becomes a very low-pressure loss device to conserve available work to be extracted by the gas turbine engine when the combustor is not fired, and hence, there is no injection of fluid and the wake region is minimized

While only certain features of the invention have been illustrated and described herein, many modifications and changes will occur to those skilled in the art. It is, therefore, to be understood that the appended claims are intended to cover all such modifications and changes as fall within the true spirit of the invention.

1. A gas turbine engine comprising:
a combustor;
a reheat combustor located downstream of the combustor;
a flame stabilizer having a body in fluid communication with the reheat combustor, wherein the flame stabilizer creates a flow recirculation zone by injection of fluid through a plurality of holes in the body of the flame stabilizer.

2. The gas turbine engine according to claim 1, wherein the body of the flame stabilizer has an aerodynamic shape that minimizes pressure loss in the gas turbine engine when no fuel is being provided to the reheat combustor.

3. The gas turbine engine according to claim 1, wherein a magnitude of the flow recirculation zone is controlled by forming the plurality of holes at an angle with respect to a longitudinal axis of the flame stabilizer.

4. The gas turbine engine according to claim 1, wherein a magnitude of the flow recirculation zone is controlled by modulating a flow rate of the fluid through the plurality of holes.

5. A flame stabilizer for a gas turbine engine having a combustor, the flame stabilizer comprising a body having a plurality of holes, wherein the flame stabilizer creates a flow recirculation zone in the combustor by injection of fluid through the plurality of holes in the body of the flame stabilizer.

6. The flame stabilizer according to claim 5, wherein the body of the flame stabilizer has an aerodynamic shape that minimizes pressure loss in the gas turbine engine when no fuel is being provided to the combustor.

7. A method of increasing efficiency of a gas turbine engine comprising creating a flow recirculation zone by way of an injection of fluid through holes in a fluidic combustor stabilizer that is in fluid communication with a reheat combustor of the gas turbine engine.

8. The method according to claim 7, further comprising shaping the flame stabilizer as an aerodynamic body that minimizes pressure loss in the gas turbine engine when no fuel is being provided to the reheat combustor.

9. The method according to claim 7, further comprising controlling a magnitude of the flow recirculation zone by forming the plurality of holes at an angle with respect to a longitudinal axis of the flame stabilizer.

10. The method according to claim 7, further comprising controlling a magnitude of the flow recirculation zone by modulating a flow rate of the fluid through the plurality of holes.
